(19) United States
(12) Patent Application Publication
(10) Pub. No.: US 2015/0144518 A1
(43) Pub. Date: May 28, 2015

(54) STICK PACK POUCH PACKAGING

(71) Applicant: McNeil-PPC, Inc., Skillman, NJ (US)

(72) Inventors: Sabu Mathew, Dresher, PA (US); Raymond Scott Shorts, Hatfield, PA (US); Mark A. Plezia, Sellersville, PA (US)

(21) Appl. No.: 14/553,238

(22) Filed: Nov. 25, 2014

Related U.S. Application Data
(60) Provisional application No. 61/909,423, filed on Nov. 27, 2013.

(51) Int. Cl. A61J 1/06; B65D 75/58; A61J 1/14

(52) U.S. Cl. CPC A61J 1/067; A61J 1/1475; B65D 75/5811; B65D 75/585
USPC 206/484; 383/208

(57) ABSTRACT

A stick pack pouch package comprising a foil sheet having side edges and first and second edges extending transversely between the side edges, a longitudinal sealing joint extending between the side edges to form the foil sheet into a tube, wherein the tube has a front side and a back side, and wherein the longitudinal sealing joint is on the back side, first and second transverse sealing joints sealing the first and second edges, respectively, a weakened pattern which extends over/across at least a portion of the longitudinal sealing joint, the back side of the tube, and the front side of the tube, wherein the weakened pattern enables the package to be opened along the pattern and wherein the weakened pattern includes nonlinear portions on the front side, back side, or front and back sides of the tube.

### CROSS-REFERENCE TO RELATED APPLICATIONS

This application claims priority of the benefits of the filing of U.S. Provisional Application Ser. No. 61/909423, filed Nov. 27, 2013, the contents of which are incorporated by reference in its entirety.

### BACKGROUND OF THE INVENTION

1. Field of the Invention

The present invention relates to packaging. More particularly, the present invention relates to stick pack pouch packaging.

2. Related Background Art

Stick pack pouch packaging is used for holding dry powders or liquids in a flexible pouch or sachet. In many instances, this type of packaging would lend itself to pharmaceutical and over the counter medicinal products, which contain active pharmaceutical ingredients. For these applications, the package is often designed with child resistant features to prevent or reduce the possibility of a child opening the package. Typically, a child resistant package has one or more child resistant features, which require the package to be manipulated in a particular manner to open it. These features prevent or hinder a child from gaining access to the contents of the package, but are not so difficult to open as to prevent an adult from opening it. In particular, it is desirable to make the package senior friendly, that is so an elderly adult can readily open the package.

The present invention is designed to provide child resistance to a stick pack pouch package containing an active pharmaceutical ingredient.

### SUMMARY OF THE INVENTION

The present invention is directed to a stick pack pouch package comprising a foil sheet having side edges and first and second edges extending transversely between the side edges, a longitudinal sealing joint extending between the side edges to form the foil sheet into a tube, wherein the tube has a front side and a back side, and wherein the longitudinal sealing joint is on the back side, first and second transverse sealing joints sealing the first and second edges, respectively, a weakened pattern which extends over/across at least a portion of the longitudinal sealing joint, the back side of the tube, and the front side of the tube, wherein the weakened pattern enables the package to be opened along the pattern and wherein the weakened pattern includes nonlinear portions on the front side, back side, or front and back sides of the tube.

The present invention is also directed to a stick pack pouch package comprising a foil sheet having two side edges and first and second edges extending transversely between the side edges, a longitudinal sealing joint extending between the side edges to form the foil sheet into a tube, wherein the tube has a front side and a back side, and wherein the longitudinal sealing joint is on the back side, first and second transverse sealing joints sealing the first and second edges, an opening aid identifying a fold line that is (a) horizontal to the first and second edges or (b) at a 30° to 60° angle relative to the first and second edges, a weakened pattern at least partially exposed upon folding the package along the fold line, and wherein the package is opened by tearing along the weakened pattern.

### BRIEF DESCRIPTION OF THE DRAWINGS

The detailed description will be better understood in conjunction with the accompanying drawings, wherein like reference characters represent like elements, as follows:

FIG. 1 is a front view of a foil sheet used to manufacture a stick pack pouch package according to the invention;

FIG. 2 is a front view of a stick pack pouch package according to the invention, where the dotted lines represent the first and second traverse seals and the longitudinal edge seal of the pouch and drawn below this is a section through the packaging;

FIG. 3 is a back view of the stick pack pouch package of FIG. 2, and drawn below this is a section through the packaging;

FIG. 4 is a plan view of another embodiment of the invention, where the weakened pattern includes an inverted “V” shaped portion;

FIG. 5 is a front view of another embodiment of a foil sheet used to manufacture a stick pack pouch package according to the invention;

FIG. 6 is a front view of a stick pack pouch package according to the invention, where the dotted lines represent the first and second traverse seals and the longitudinal edge seal of the pouch and drawn below this is a section through the packaging;

FIG. 7 is a back view of the stick pack pouch package of FIG. 6, and drawn below this is a section through the packaging; and

FIGS. 8A-8I depict various embodiments where the packages have nonobvious weakened patterns.

### DETAILED DESCRIPTION OF THE INVENTION

As used herein, “at least partially” is understood to mean a portion thereof or the entirety thereof

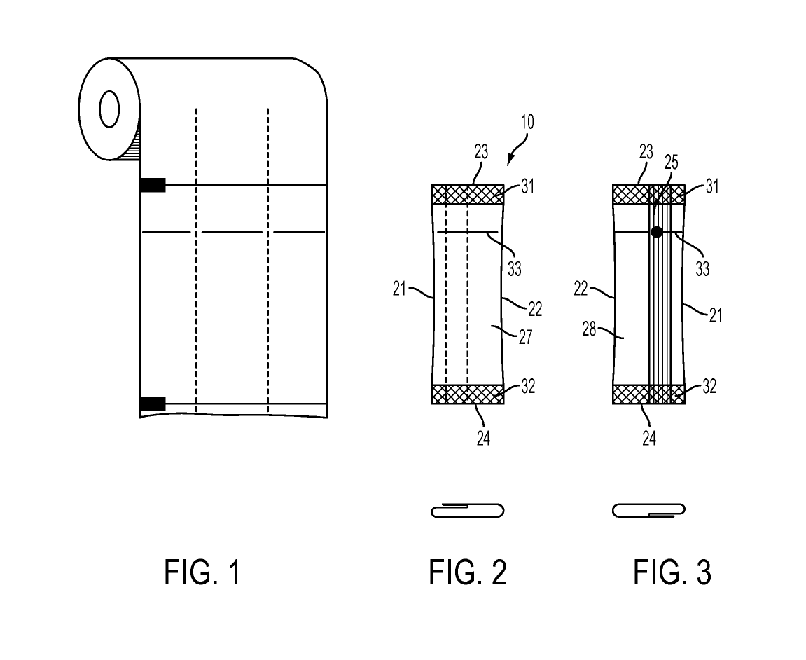

FIG. 1 depicts a foil sheet used to manufacture a stick pack pouch package of the invention.

In FIG. 2, a stick pack pouch package 10 is shown with side edges 21, 22 and first edge 23 and second edge 24 extending transversely between the side edges. As shown in FIG. 3, the stick pack pouch package also includes a longitudinal sealing joint 25 extending between the side edges to form the foil sheet into a tube. The tube has a front side 27 and a back side 28, and the longitudinal sealing joint is typically positioned along the back side. The package further includes first traverse sealing joint 31 and second transverse sealing joint 32, which seal the first and second edges, respectively. A weakened pattern 33 extends over/across at least a portion of longitudinal sealing joint 25, the back side 28 of the tube, and the front side 27 of the tube.

The weakened pattern 33 enables the package 10 to be opened along the pattern and includes nonlinear portions on the front side 27, back side 28, or front and back sides of the tube 25.

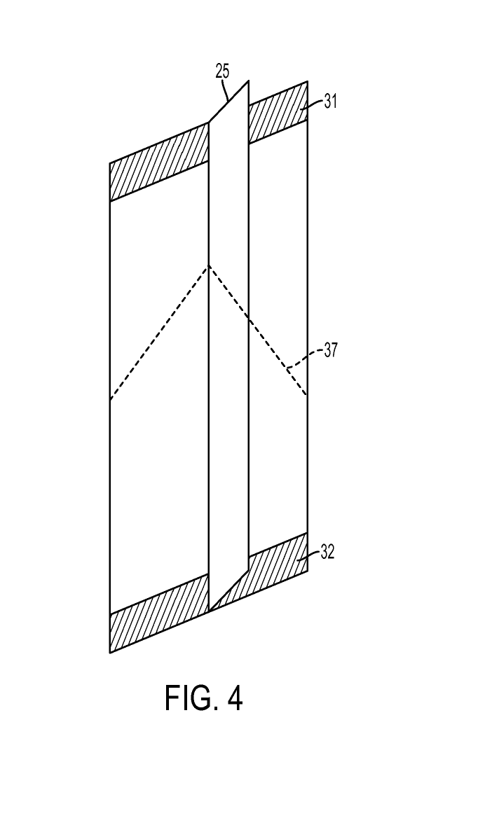

The weakened pattern forms the shape of a spout. The spout becomes apparent when the package 10 is opened, and aids in the pouring of product out of the package. In one embodiment, the weakened pattern 33 may include a “V” shape 37 on the front, back, or front and back sides of the package. In another embodiment, shown in FIG. 4, the “V” shape is inverted. The “V” shape or inverted “V” shape in the weakened pattern, is the outline of the spout.

The foil sheet is comprised of film-like laminate material, which is multilayer, e.g., two layers, three layers, four layers, or more. The individual material layers can be lacquer applications, metal films, metallised coatings or films of plastics, or laminates of metal films and plastic films.

Suitable plastic films are suitably made of thermoplastics, such as, polyesters, polyolefins such as polypropylenes or polyethylenes, polyamides, polyvinyl chloride, polycarbonate, etc., or cellulose-containing materials such as cellophane. Plastic films can be monofilms or film laminates.

The laminate material has a weakened pattern or areas in at least one material layer of the laminate material. In one embodiment, the weakened pattern is provided on the first material layer of the laminate material. In another embodiment the weakened pattern is on the second material layer or on the first and second layers of the laminate material.

The weakened pattern may be applied to the foil sheet, e.g., laminate material by any suitable means. For example, the weakened pattern can be generated mechanically, for example, by blades such as oscillating blades, rotating blades fitted to a cylinder, punch blades or needles, etc., or by the use of light energy, e.g., laser beams or electron beams, which lead to the formation of microperforations. The weakened areas are applied to one or more layers in register with the printing. This enables alignment of the weakened areas and the printing on the packaging material. It should be understood that other means may be used to apply the weakened pattern onto the foil sheet.

Perforations may, or may not, be identical to each other, and may be allocated in any pattern or layout. Moreover, the perforations may have sizes and/or shapes that are the same as, or different from, each other. In some embodiments, portions of the weakened pattern may have uniformly distributed perforations, while some other portions may have non-uniformly distributed perforations. That is, the density and the location of the perforations may be adjusted according to the desired pattern. For example, the weakened pattern may be continuous, noncontinuous, or include continuous portions and noncontinuous portions. In addition, the perforations may have varying depths so as to vary the difficulty or ease of tearing the package open.

Desirably, the weakened pattern when opened has the shape of a spout and aids in the pouring of product out of the package. In one embodiment, the weakened pattern may include a “V” shape on the front, back, or front and back sides of the package. In another embodiment, the “V” shape is inverted.

The weakened pattern may be designed to enable the package to be opened from a variety of locations. In one embodiment, the weakened pattern enables the package to be opened along the longitudinal sealing joint. In another embodiment, the package is opened from the left or right side of the tube. In yet another embodiment, the package is opened from the front or back side of the tube.

The stick pack pouch package can have a variety of dimensions depending upon the design or product needs. In one embodiment, the package has a length of from about 10 mm to about 150 mm, more preferably from about 50 mm to about 120 mm, and a width of from about 10 mm to about 50 mm, more preferably from about 20 mm to about 50 mm.

In one embodiment, the sealed joints have a width of from about 2 mm to 25 mm for the longitudinal sealing joint and from about 3 mm to about 12 mm for the first and second transverse sealing joints.

The stick pack pouch package may be used to hold any dry or liquid product. For example, the package may be used for holding medicinal products in a powder, granule, or liquid form.

In one embodiment, the first and second traverse sealing joints have rounded interior corners. The rounded corners advantageously facilitate the flow of the product out of the package and reduce the tendency for the product to get trapped in the corners.

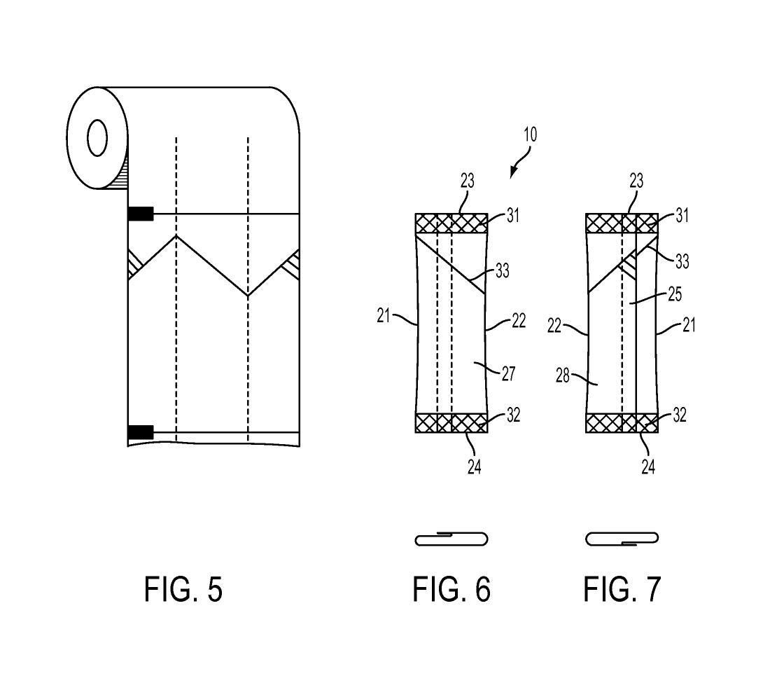

As shown in FIGS. 5, 6 and 7, the present invention is also directed to a stick pack pouch package 10 comprising a foil sheet having two side edges 21, 22 and first 23 and second 24 edges extending transversely between the side edges, a longitudinal sealing joint 25 extending between the side edges to form the foil sheet into a tube, wherein the tube has a front side 27 and a back side 28, and wherein the longitudinal sealing joint is on the back side, first 31 and second 32 transverse sealing joints sealing the first and second edges, an opening aid identifying a fold line that is (a) horizontal to the first and second edges or (b) at a 30° to 60° angle relative to the first and second edges, a weakened pattern 33 at least partially exposed upon folding the package along the fold line, and wherein the package is opened by tearing along the weakened pattern.

The opening aid serves to help the user identify the fold line on the package. Any means of identifying the fold line may be used. Non-limiting examples include, (i) a line going across the package labelled as a fold line, (ii) a visible dot on the package with a line running through the dot indicating where to fold the package, or (iii) text telling the user to “fold here.” Once the package is folded at the fold line, the weakened pattern is exposed or becomes evident. In one embodiment, the fold line is horizontal to the first and second edges of the package. In another embodiment, the fold line would run diagonal to the first and second edges of the package. Preferably, the fold line would be at a 20° to 75° angle relative to the first and second edges, more preferably, at a 30° to 60° angle relative to the first and second edges.

The user can then initiate a tear along the weakened pattern to open the package. The weakened pattern may be positioned at any point in immediate proximity to the fold line and at any angle to the fold line, so long as upon application of sufficient tearing forces, the tear progresses through and follows the pattern of the weakened pattern. It should be understood that the tearing forces sufficient to open the package may be adjusted to achieve the desired level of child resistancy. In one embodiment, the weakened pattern is at a 20° to 75° angle relative to the fold line. In another embodiment, the weakened pattern is perpendicular to the fold line.

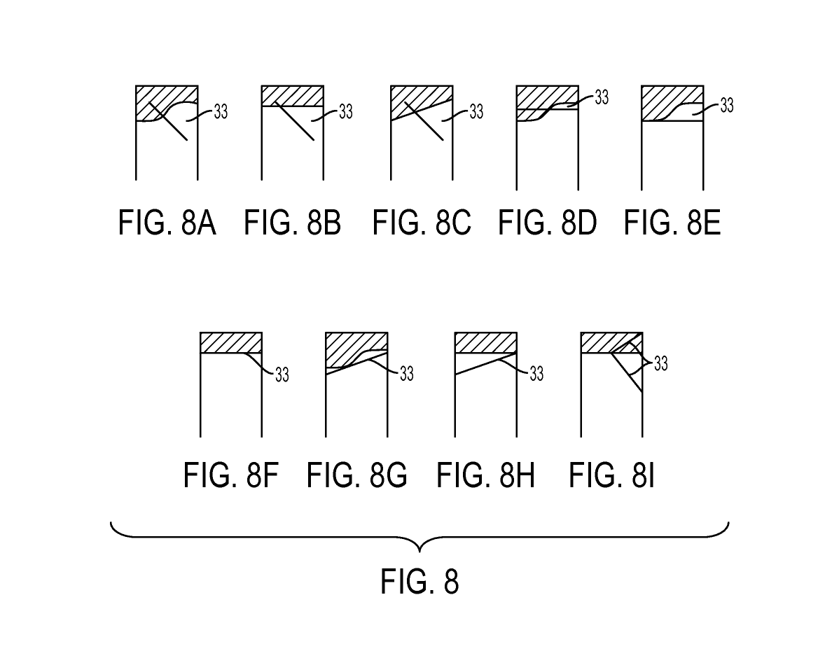

In FIGS. 8A-8I, examples of various embodiments where the packages have nonobvious weakened patterns are shown.

While the invention has been described above with reference to specific embodiments thereof, it is apparent that many changes, modifications, and variations can be made without departing from the inventive concept disclosed herein. Accordingly, it is intended to embrace all such changes, modifications, and variations that fall within the spirit and broad scope of the appended claims. All patent applications, patents, and other publications cited herein are incorporated by reference in their entirety.

What is claimed is:

1. A stick pack pouch package comprising:
a foil sheet having side edges and first and second edges extending transversely between the side edges,
a longitudinal sealing joint extending between the side edges to form the foil sheet into a tube, wherein the tube has a front side and a back side, and wherein the longitudinal sealing joint is on the back side,
first and second transverse sealing joints sealing the first and second edges, respectively,
a weakened pattern which extends over/across at least a portion of the longitudinal sealing joint, the back side of the tube, and the front side of the tube, wherein the weakened pattern enables the package to be opened along the pattern and wherein the weakened pattern includes nonlinear portions on the front side, back side, or front and back sides of the tube.

2. The package of claim 1, wherein the weakened pattern is in the shape of a spout.

3. The package of claim 2, wherein the spout aids the pouring of product out of the package.

4. The package of claim 1, wherein the package is opened from the longitudinal sealing joint.

5. The package of claim 1, wherein the package is opened from a left or a right side of the tube.

6. The package of claim 1, wherein the package is opened from the front or back side of the tube.

7. The package of claim 1, wherein the weakened pattern forms a “V” shape on the front, back, or front and back sides of the package.

8. The package of claim 7, wherein the “V” shape is inverted.

9. The package of claim 1, wherein the weakened pattern is formed by light energy or mechanical means.

10. The package of claim 9, wherein the weakened pattern is formed by microperforations or laser perforations.

11. The package of claim 1, wherein the weakened pattern is continuous.

12. The package of claim 1, wherein the weakened pattern is noncontinuous.

13. The package of claim 1, wherein the weakened pattern includes continuous portions and noncontinuous portions.

14. The package of claim 1, wherein the first, second, or first and second traverse sealing joints have rounded interior corners.

15. A stick pack pouch package comprising:
a foil sheet having two side edges and first and second edges extending transversely between the side edges,
a longitudinal sealing joint extending between the side edges to form the foil sheet into a tube, wherein the tube has a front side and a back side, and wherein the longitudinal sealing joint is on the back side,
first and second transverse sealing joints sealing the first and second edges,
an opening aid identifying a fold line that is (a) horizontal to the first and second edges or (b) at a 30° to 60° angle relative to the first and second edges,
a weakened pattern at least partially exposed upon folding the package along the fold line, and
wherein the package is opened by tearing along the weakened pattern.

16. The package of claim 15, wherein a portion of the weakened pattern is in the shape of a spout.

17. The package of claim 16, wherein the spout aids the pouring of product out of the package.

18. The package of claim 15, wherein the package is opened from the longitudinal sealing joint.

19. The package of claim 15, wherein the package is opened from a left or a right side of the tube.

20. The package of claim 15, wherein the package is opened from the front or back side of the tube.

21. The package of claim 15, wherein the weakened pattern forms a “V” shape on the front, back, or front and back sides of the package.

22. The package of claim 21, wherein the “V” shape is inverted.

23. The package of claim 15, wherein the weakened pattern is formed by light energy or mechanical means.

24. The package of claim 23, wherein the weakened pattern is formed by microperforations or laser perforations.

25. The package of claim 15, wherein the weakened pattern is continuous.

26. The package of claim 15, wherein the weakened pattern is noncontinuous.

27. The package of claim 15, wherein the weakened pattern includes continuous portions and noncontinuous portions.

28. The package of claim 15, wherein the first, second, or first and second traverse sealing joints have rounded interior corners.
